(19) United States
(12) Patent Application Publication
(10) Pub. No.: US 2012/0249055 A1
(43) Pub. Date: Oct. 4, 2012

(54) INDIVIDUAL CELL CHARGER AND METHOD OF USING SAME

(75) Inventor: John M. Wade, Ramona, CA (US)

(73) Assignee: GRRREEN, Inc., a Delaware corporation, Solana Beach, CA (US)

(21) Appl. No.: 13/075,152

(22) Filed: Mar. 29, 2011

(51) Int. Cl. H02J 7/04

(52) U.S. Cl. 320/107; 320/119

(57) ABSTRACT

An individual cell charger and method of using it are disclosed. The voltage of each individual battery cell of a series connected cell configuration, is measured. A controlled power source charges the cells individually at an initial voltage. The voltage on each individual one of the charged cells is subsequently measured by a battery management system. The voltage of the controlled power source is incrementally increased to charge the cells individually at an incrementally higher voltage. The measuring and charging of each individual cell is repeated until the voltage on at least one of the cells reaches a predetermined voltage. Once the voltage on at least one of the cells reaches a predetermined voltage, the measuring and charging each individual cell continues at substantially the same last incremental voltage.

### RELATED PATENT APPLICATIONS

This present non-provisional patent application hereby incorporates by references U.S. patent application Ser. No. ______ (20679-103), filed Mar. 29, 2011, entitled BATTERY CHARGING SYSTEM AND METHOD; U.S. patent application Ser. No. ______ (20679-104), filed Mar. 29, 2011, entitled INTELLIGENT BATTERY MANAGEMENT SYSTEM AND METHOD; and U.S. patent application Ser. No. 12/650,401 filed Dec. 30, 2009, entitled SYSTEMS AND METHODS FOR MANAGING CHARGE AND DISCHARGE FOR BATTERIES.

### FIELD OF THE INVENTION

The present invention relates in general to an individual cell charger and a method of using it. It more particularly relates to an individual cell charger and method for charging multi-cell series connected batteries.

### BACKGROUND ART

This section describes the background art of the disclosed embodiment of the present invention. There is no intention, either express or implied, that the background art discussed in this section legally constitutes prior art.

There is a need for an individual cell battery charger which is primarily to insure that all cells become fully charged and balanced in a fast expeditious manner. In this regard, battery cell balance is an issue during charging operations for multi-cell series connected batteries. This may be particularly true for Lithium ion cells. If one cell in a series string charges significantly differently from the others, it can cause performance to be degraded.

A conventional method of individual cell charging is to provide a charger for each cell comprised of an individual switcher with its associated transformer (or transformer winding), rectifiers, filters and control circuitry. For charging a multi cell battery pack this approach may be expensive to manufacture, may be bulky and may have limited reliability because it involves many parts.

### BRIEF DESCRIPTION OF THE DRAWINGS

In order to better understand the invention and to see how the same may be carried out in practice, non-limiting preferred embodiments of the invention will now be described with reference to the accompanying drawings, in which:

FIG. 1 is a schematic circuit diagram of an individual cell charger, which is constructed according to an embodiment of the present invention.

### DETAILED DESCRIPTION OF CERTAIN EMBODIMENTS OF THE INVENTION

Certain embodiments of the present invention will now be described more fully hereinafter with reference to the accompanying drawings, in which some, but not all, embodiments of the invention are shown. Indeed, these embodiments of the invention may be in many different forms and thus the invention should not be construed as limited to the embodiments set forth herein; rather, these embodiments are provided as illustrative examples only so that this disclosure will satisfy applicable legal requirements. Like numbers refer to like elements throughout.

It will be readily understood that the components of the embodiments as generally described and illustrated in the drawings herein, could be arranged and designed in a wide variety of different configurations. Thus, the following more detailed description of the certain ones of the embodiments of the system, components and method of the present invention, as represented in the drawings, is not intended to limit the scope of the invention, as claimed, but is merely representative of the embodiment of the invention.

An individual cell charger and method of using it are disclosed. The voltage of each individual battery cell of a series connected cell configuration is measured. A controlled power source charges the cells individually at an initial voltage. The voltage on each individual one of the charged cells is subsequently measured by a battery management system. The voltage of the controlled power source is incrementally increased to charge the cells individually at an incrementally higher voltage. The measuring and charging of each individual cell is repeated until the voltage on at least one of the cells reaches a predetermined voltage. Once the voltage on at least one of the cells reaches a predetermined voltage, the measuring and charging each individual cell continues at substantially the same last incremental voltage.

According to an embodiment of the present invention, an individual cell charger is provided which is greatly simplified as compared with a conventional approach, partly due to its integration with a Battery Management System, or BMS, resulting in a small, inexpensive component count.

A conventional BMS usually has the capability to measure the voltage of each individual cell in a multi-cell battery. Its usual function is to act on the monitored data to avoid over charging or over discharging any of the cells. It is this voltage measuring capability that makes it useful when integrated with the present embodiment of the individual cell charger of the present invention.

An embodiment of the invention relates to an individual cell charger, which measures voltage increases on all of the cells and then charges alternating ones of a first set of the cells only. The charger then determines that voltage increases on all cells are within predetermined limits. The charger then switches to alternating ones of a second set of the cells and charges them with a higher charging current. This cycle continues until at least one of these cells has reached the predetermined limit. The one or more cells having reached the predetermined limit are no longer charged, and the remaining cells are continued to be charged at the last charging current. This charging cycle is continued until all of the cells reach the pre-determined limit.

By utilizing the disclosed embodiments of the invention, the individual cell charger ensures that each cell becomes fully charged during each charge cycle. According to the prior art, where the series connected cells were charged across the entire series and not individually, individual cells could lag behind and never become fully charged. This is particularly true for lithium ion batteries. In this manner, the battery could be determined to be discharged prematurely due to the lagging cell not being fully charged, even though the remaining cells were not fully discharged and still capable of functioning. Also, such a lagging cell which does not become fully charged during each charge cycle, may require early replacement.

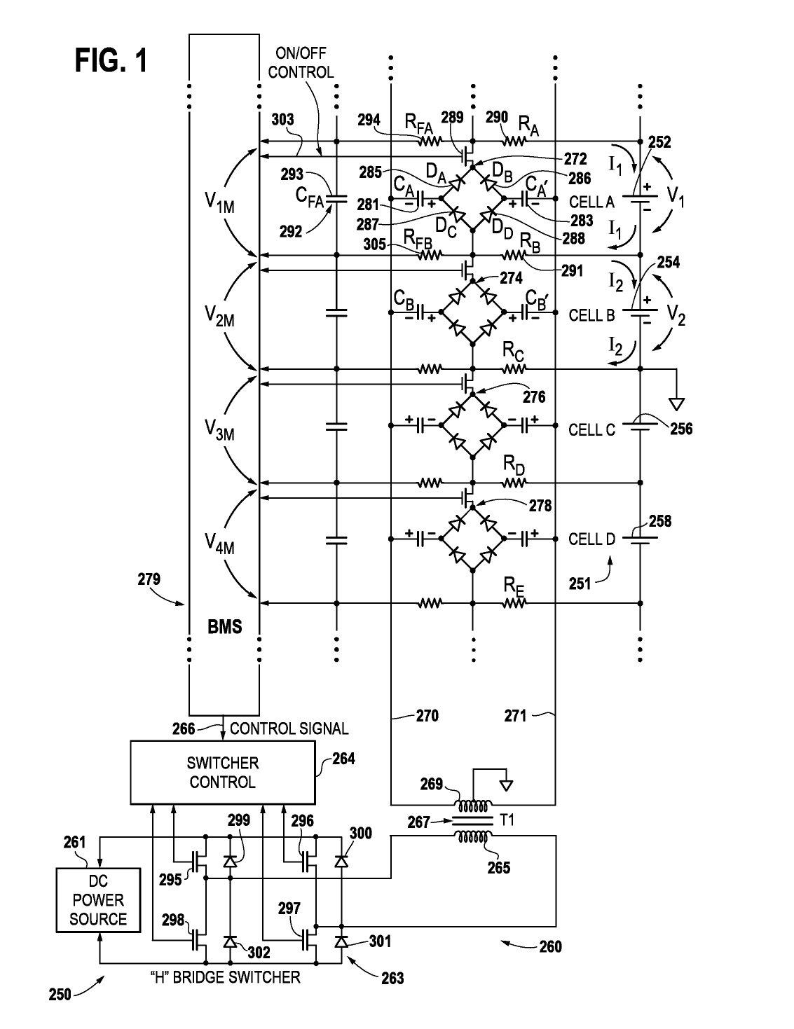

Considering now the drawings with reference to FIG. 1, there is shown an individual cell charger 250 for charging a battery generally indicated at 251 having four cells 252, 254, 256 and 258 which are also designated A, B, C, and D, respectively, and which are connected in series. There may be a fewer or larger number of cells employed. For example, the battery may comprise 16 cells to provide a 48 V pack. Each cell may be a lithium ion cell with an iron phosphate additive. Such a battery pack may be employed, for example, on a vehicle such as a neighborhood electric vehicle (not shown).

A direct current power source 261 supplies current through an H bridge switcher 263 under the control of a switcher control 264 to the primary winding 265 of a transformer 267. The switcher control 264 causes the duty cycle of the switcher 263 to create alternating current flowing through the primary 265 of the transformer 267. A secondary winding 269 of the transformer 267 is connected across a double rail pair of conductors 270 and 271 to provide alternating current to a set of capacitor coupled bridge rectifiers 272, 274, 276 and 278 for supplying rectified current individually to the cells 252, 254, 256 and 258, respectively.

A battery management system (BMS) 279 measures the voltage on each cell during a charging operation and can selectively connect charging current to the cells by selectively coupling the charging current to individual ones of the cells or disconnecting or decoupling the charging current from cells reaching the predetermined voltages. A control signal lead 266 from the BMS 279 to the switcher control 264 causes the switcher 263 to increase or decrease its duty cycle incrementally. The BMS 279 may be similar to the battery management system disclosed in U.S. patent application Ser. No. 12/650,401, filed Dec. 30, 2009, which is incorporated herein by reference.

Each one of the bridge rectifiers such as the bridge rectifier 272 is coupled between the double rail conductors 270 and 271 by capacitors such as a pair of capacitors 281 and 283 for the rectifier 272. The capacitors 281 and 283 are each preferably low effective series resistance capacitors, such as functional polymer electrolytic capacitors. Each one of the bridge rectifiers such as the bridge rectifier 272 includes four diodes such as the diodes 285 through 288 for the bridge rectifier 272. Each bridge rectifier supplies energy to its cell such as the cell 252 (cell A) by a switch such as a switch 289 which are controlled by the battery management system 297 by ON/OFF CONTROL leads such as the lead 303. A pair of small current sense resistors 290 and 291 connect the bridge rectifier 272 to the cell 252.

A set of four low pass filters are provided for the four bridge rectifiers. The four low pass filters are similar to one another, and include a low pass filter 292 comprising a capacitor 293, resistor 294 and the resistor 305, for the bridge rectifier 272. The filtered output of bridge rectifier 272 is fed to the BMS 279.

The switcher 263 includes a set of four switches 295 through 298 connected in an H bridge configuration. A set of four diodes 299 through 302 are connected individually and are suitably poled across each one of the switches 295 through 298, respectively. The switcher control 264 selectively controls the switcher switches to alternately reverse current flow through the primary 265 of the transformer 267. For example, when the switches 295 and 297 are activated and the other two switches 296 and 298 are deactivated, current flows from the DC power source 261 through the switch 295, through the primary 265 and the switch 297, and back to the power source 261. Thereafter, the switches 295 and 297 are switched off for a time, and then later switches 296 and 298 are turned on, to provide the alternating current flow through the winding 265. There will be inductive current in the winding 265 when the switches turn off, and it flows through the diode 302 to the winding 265 and back through the diode 300 to the power source 261 just after switches 295 and 297 turn off. Likewise, current flows through diode 301, winding 265 and diode 299 after switches 296 and 298 turn off.

As shown in FIG. 1, the cells A, B, C, and D represent cells that are discharged and ready to be charged. The “H Bridge” switcher 263 is connected to the DC power source 261 which could alternately be rectified and filtered mains or another DC source (not shown). The switcher 263 drives the primary 265 of transformer T₁, the secondary 269 of which drives the parallel group of capacitor coupled bridge rectifiers, each corresponding to a cell in the series connected battery string. The capacitor coupling provides DC isolation of the winding from the different DC voltage levels of the cells.

The output of each bridge rectifier is fed through an off/on switch such as switch 289, and small value current sense resistors such as R_{A} and R_{B} (resistors 290 and 291, respectively), to its corresponding cell, such as cell A. It is also fed through the low pass filter such as the circuit including resistors R_{FA}, R_{FB}, and capacitor C_{FA} to the cell voltage monitoring terminals of a BMS.

When charging is not taking place, no current flows through the bridge rectifiers and the filtered cell voltages are fed through to the BMS so it can perform its normal cell monitoring function. When charging is taking place, however, the switcher feeds an AC signal into the primary winding of the transformer T₁, causing an AC output on its secondary. The secondary voltages are AC coupled to the bridge rectifiers such as the rectifier 272 including diodes D_{A}, D_{B}, D_{C}, and D_{D}, causing rectified current such as I₁ to flow through them and through the cells such as cell A, providing it is switched on, thus charging the cell.

A concern, however, is that since all of the discharged cells may not be at the same voltage prior to charging, the lowest voltage cell limits the amplitude of the AC voltage from the transformer, and may draw current that is excessive, especially for the coupling capacitors and/or the bridge rectifiers. The disclosed embodiments of the present invention are designed to avoid, or at least greatly reduce this situation.

According to the method of the disclosed embodiments of this invention, prior to charging, the switcher 263 is off, and the BMS 279 monitors the voltage of all cells to establish a baseline. It then switches on alternate cells, such as cell A and C and then initiates the switcher 263 at its lowest or initial duty cycle by means of the switch control 264 in response to the control signal from the BMS 279 while monitoring the cells.

The BMS 279 then determines which, if any of the voltages have increased in voltage. An increase would occur if a current such as I₁ flowed from a cell's rectifiers through the small current sense resistors 290 and 291. The measured voltage, V_{1M}, would be the sum of the cell voltage V₁ plus the voltage drop across the current sense resistors caused by the charge current neglecting the internal cell resistance, which in this case is small by comparison. If the voltage increase is within a preset limit, then therefore the amount of charge current is satisfactory and the process is then repeated. This time an alternate set of cells, such as cells B and D are switched on, and the cells A and C are switched off. It is then determined whether or not the voltage has increased within the preset limit, and the charge current is satisfactory. If in either case the voltage increase exceeds the limit, the BMS 279 concludes that a cell is faulty such as being shorted, and the BMS then stops the charge cycle, and provides a status indication.

The voltage limit is set by calculating a voltage increase based on a target value for cell charge current, such as I₁, where I₁=(V_{1M}−V₁)/(R_{A}+R_{B}). It is assumed that no current flows into the BMS 279 through resistors R_{FA} and R_{FB}, and they therefore have no steady state influence on the measured voltage V_{1M}.

If the voltage increase is within the limit for both sets of cells, the BMS 279 increases the switcher duty cycle by one increment to increase the overall current flow, and repeats the above process. It continues to do so until the voltage increase of at least one cell has reached the predetermined limit and therefore its current is at its predetermined limit. Thereafter, as charging continues at that current level, the voltage on that cell continues to increase until it is close to a voltage on another. At that point, some of the charge current will begin to flow into other cells. Thus, the current in the first cell will start to decline. Subsequent measurements will detect that, and the charge current increases until at least one cell is being charged at its maximum current. This means that the maximum acceptable current is flowing into at least one cell, and no other cells are drawing excessive current.

The BMS 279 then turns on all cells, and charges at the last duty cycle setting for a predetermined period of time, preferably 5 seconds. After this charging has occurred, the cell voltages may have increased, so the charging is stopped and the cell voltages are again read to establish a new baseline.

Next, the switcher 263 is restarted at the same duty cycle that it left off and voltage increases are again measured in two groups, as before. If the increases are less than the maximum acceptable value, the duty cycle is incremented up again and measurements taken until at least one more cell reaches the maximum. If the increases are above the maximum value the duty cycle is decremented until they are all within the limit.

As the cycle is repeated, and the lowest voltage cell or cells become partially charged, the transformer voltage will be at successively higher values, and current begins to flow into other cells that had higher initial voltages, as well as continuing to flow into the cell or cells that initially had the lowest voltage. This process continues until the baseline voltages of all the cells are at the full charge value whereupon the charging algorithm is complete and charging stops. At this point the cells are also balanced.

In accordance with a presently preferred embodiment of the invention, the voltage increase measurements may be taken with pairs of alternate cells only, on at one time to avoid current flowing into an adjacent cell and causing an error. For example, in FIG. 1, if current I₂ flowed through cell B while a voltage increase measurement was being made for cell A, an error would occur since both I₁ and I₂ would determine the voltage drop across resistor R_{B} instead just I₁ alone. The voltages are measured through a low pass filter to average the voltage pulses caused by switcher current pulses. Although four cells are shown in the drawings, the concept is expandable to a larger or fewer number of cells.

Although the invention has been described with reference to the above examples, it will be understood that many modifications and variations are contemplated within the true spirit and scope of the embodiments of the invention as disclosed herein. Many modifications and other embodiments of the invention set forth herein will come to mind to one skilled in the art to which the invention pertains having the benefit of the teachings presented in the foregoing descriptions and the associated drawings. Therefore, it is to be understood that the invention shall not be limited to the specific embodiments disclosed and that modifications and other embodiments are intended and contemplated to be included within the scope of the appended claims. Although specific terms are employed herein, they are used in a generic and descriptive sense only and not for purposes of limitation.

What is claimed is:

1. A method of charging series connected battery cells individually, comprising:
measuring voltages on all of the cell;
charging from a source of power alternating ones of a first set of these cells only;
determining using a battery management system that voltage increases on all cells are within predetermined limits;
switching the power source using a switcher to the alternating ones of a second set of the cells;
charging from the source of power the second set of the cells with a higher charging current; and
charging all of these cells until at least one of these cells has reached the predetermined limit at the last value of the charging current.

2. The method according to claim 1, wherein when the voltage on at least one of the cells is determined to exceed the predetermined limit, indicating that the at least one cell is faulty.

3. An individual cell battery charger for charging a group of series connected battery cells, comprising:
a controlled power source for supplying charging current to the cells to be charged;
a plurality of switches to connect the charging current to individual ones of the cells;
a battery management system for selectively interconnecting the controlled power source to selected ones of the cells; and
wherein the battery management system measures the voltage on each one of the cells and increases the charging current from the controlled power source incrementally until the voltage on all of the cells reaches a predetermined voltage; and
wherein the battery management system causes the switches to connect selectively, alternate ones of the cells to the controlled power source.

4. An individual cell battery charger according to claim 3, wherein the battery management system causes the controlled power source to maintain its charging current constant once at least one of the cells reaches a predetermined voltage until all of the cells reach the predetermined voltage.

5. An individual cell battery charger according to claim 4, wherein the battery management system causes the controlled power source to decrement its charging current when the voltage on at least one of the cells reaches the predetermined voltage and continues to cause the cells to be charged with the decremented charging current.

6. An individual cell battery charger according to claim 4, wherein the battery management system causes an indication that at least one cell is faulty when the charging current exceeds the predetermined voltage.

7. An individual cell battery charger according to claim 3, wherein the controlled power source includes a group of rectifiers corresponding to individual ones of the cells, and a transformer for supplying alternating current to the rectifiers, a bridge switches for generating the alternating current for the transformer.

8. An individual cell battery charger according to claim 7, wherein the controlled power source includes a switcher control to cause the bridge switcher to change the duty cycle of the switching rate thereof.

9. A method of charging individually a group of series connected battery cells, comprising:
measuring the voltage on each individual one of the cells;
charging the cells individually using a controlled power source at an initial voltage;
subsequently measuring the voltage on each individual one of the charged cells;
increasing the voltage of the controlled power source incrementally;
charging the cells individually at an incrementally higher voltage using the controlled power source;
repeating the measuring and charging of each individual one of the cells until the voltage on at least one of them reaches a predetermined voltage;
subsequently repeating the measuring and charging each individual one of the cells at the last incremental voltage of the controlled power source until the voltage on all of the cells reaches the predetermined voltage, unless the voltage on at least one of the cells exceeds the predetermined voltage; and
subsequently repeating the measuring and charging each individual one of the cells at an incrementally lower voltage of the controlled power source until the voltage on all of the cells reaches the predetermined voltage.

10. The method according to claim 9, wherein providing an indication that at least one of the cells is faulty if the charging current thereto exceeds a predetermined level.

11. An individual cell battery charger according to claim 9, wherein the battery management system causes the controlled power source to maintain its charging current constant once at least one of the cells reaches a predetermined voltage until all of the cells reach the predetermined voltage.

12. An individual cell battery charger according to claim 11, wherein the battery management system causes the controlled power source to decrement its charging current when the voltage on at least one of the cells reaches the predetermined voltage and continues to cause the cells to be charged with the decremented charging current.

13. An individual cell battery charger according to claim 11, wherein the battery management system causes an indication that at least one cell is faulty when the charging current exceeds the predetermined voltage.

14. An individual cell battery charger according to claim 9, wherein the controlled power source includes a group of rectifiers corresponding to individual ones of the cells, and a transformer for supplying alternating current to the rectifiers, a bridge switches for generating the alternating current for the transformer.

15. An individual cell battery charger according to claim 14, wherein the controlled power source includes a switcher control to cause the bridge switcher to change the duty cycle of the switching rate thereof.

16. An individual cell charger for charging individually a group of series connected battery cells, comprising:
means for measuring the voltage on each individual one of the cells;
means for charging the cells individually using a controlled power source at an initial voltage;
means for subsequently measuring the voltage on each individual one of the charged cells;
means for increasing the voltage of the controlled power source incrementally;
means for charging the cells individually at an incrementally higher voltage using the controlled power source;
means for repeating the measuring and charging of each individual one of the cells until the voltage on at least one of them reaches a predetermined voltage;
means for subsequently repeating the measuring and charging each individual one of the cells at the last incremental voltage of the controlled power source until the voltage on all of the cells reaches the predetermined voltage, unless the voltage on at least one of the cells exceeds the predetermined voltage; and
means for subsequently repeating the measuring and charging each individual one of the cells at an incrementally lower voltage of the controlled power source until the voltage on all of the cells reaches the predetermined voltage.

17. The charger according to claim 16, wherein providing an indication that at least one of the cells is faulty if the charging current thereto exceeds a predetermined level.
